(19) United States
(12) Patent Application Publication
(10) Pub. No.: US 2007/0220033 A1
(43) Pub. Date: Sep. 20, 2007

(54) System and method for providing simple and compound indexes for XML files

(75) Inventor: Daniel Sanders, Orem, UT (US)

Correspondence Address: HAYNES AND BOONE, LLP, 901 MAIN STREET, SUITE 3100, DALLAS, TX, 75202-3789, US

(73) Assignee: Novell, Inc., Provo, UT (US)

(21) Appl. No.: 11/377,016

(22) Filed: Mar. 16, 2006

(51) Int. Cl. G06F 7/00

(52) U.S. Cl. 707/102

(57) ABSTRACT

System and method for providing compound indexing for XML documents are described. One embodiment is a system comprising a database for storing a document comprising hierarchical, semi-structured data; a database engine for performing operations on and in connection with data stored in the database; and an index definition document (“IDD”) for defining an index for the document; wherein the database engine applies the IDD to the document to generate a set of index keys for the document.

### CROSS-REFERENCE TO RELATED APPLICATION

This application is related to commonly-owned U.S. patent application Ser. No. ______ (Atty. Docket No. IDR-921/26530.113) entitled SYSTEM AND METHOD FOR EFFICIENT MAINTENANCE OF INDEXES FOR XML FILES, filed on even date herewith and hereby incorporated by reference in its entirety.

### BACKGROUND

Retrieving information from an XML database can be costly in terms of both space and time. This is partially due to the fact that the semi-structured nature of XML does not lend itself to easy indexing. Additionally, maintaining indexes in an XML document can be difficult and time consuming. Most current XML databases have dealt with this problem by restricting the scope of the indexes, allowing only single attributes or single elements within an index. Others do not index XML as XML, instead forcing an internal conversion to a relational storage system to deal with the issue of indexing.

### SUMMARY

In response to these and other problems, in one embodiment, a system is provided for providing compound indexing for documents comprising semi-structured hierarchical data. The system comprises a database for storing a document comprising hierarchical, semi-structured data; a database engine for performing operations on and in connection with data stored in the database; and an index definition document (“IDD”) for defining an index for the document; wherein the database engine applies the IDD to the document to generate a set of index keys for the document.

### BRIEF DESCRIPTION OF THE DRAWINGS

FIG. 1 is a block diagram of an XML database system in accordance with an embodiment.

FIGS. 2A-2C illustrate syntaxes for defining an index, an ElementComponent, and an AttributeComponent, respectively, in accordance with an embodiment.

FIG. 3 illustrates an index definition document in accordance with an embodiment.

FIG. 4 is a schematic diagram of the index definition document of FIG. 3.

FIG. 5 illustrates an XML document to which the index definition document illustrated in FIG. 3 may be applied in accordance with an embodiment.

FIG. 6 is a schematic diagram of the XML document of FIG. 7.

FIG. 7 illustrates a set of index keys generated by applying the index definition document of FIG. 3 to the XML document of FIG. 5.

### DETAILED DESCRIPTION

This disclosure relates generally to XML databases and, more specifically, to a system and method for providing simple and compound indexes for such databases. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

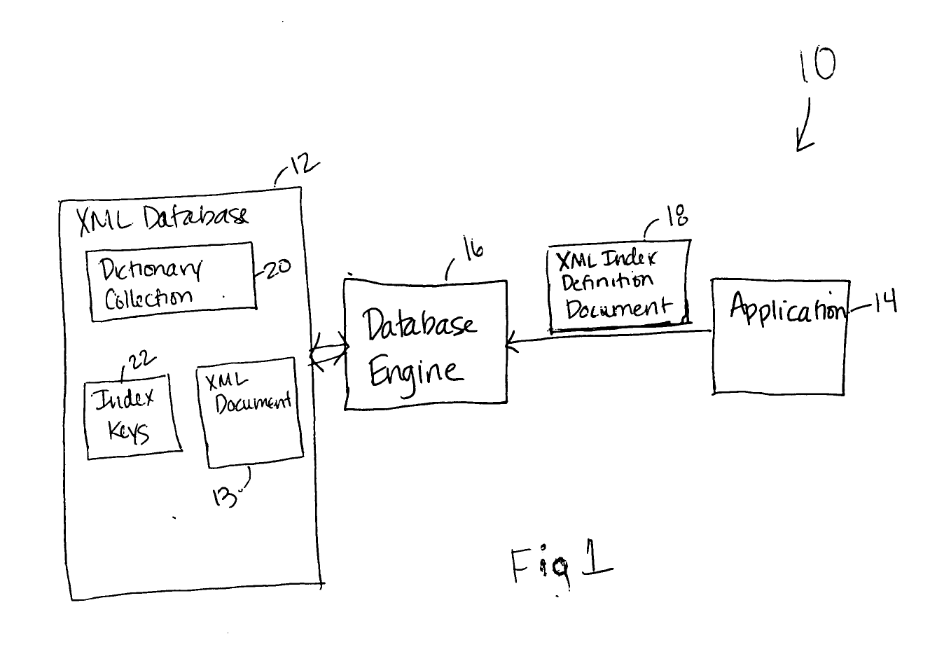

FIG. 1 is a block diagram of an XML database system 10 according to an embodiment. As shown in FIG. 1, the system 10 includes an XML database 12 in which at least one XML document 13 comprising data for one or more applications, such as an application 14, is stored. It will be recognized that the XML document 13 may actually comprise a collection of documents comprising application data for the application 14. An XML document, such as the XML document 13, is generally used to represent an object or a concept in the real world, such as a product, a customer, an employee, a business division, etc. As such, an XML document consists of a collection of nodes, such as, for example, ElementComponents or AttributeComponents, that represent information about the object. In XML, there is no requirement that the XML document 13 conform to a predefined template. In one embodiment, the XML database 12 supports the creation of arbitrarily structured documents. The creator of an arbitrarily structured document is not only allowed to determine the contents of the attributes within the document, but is also allowed to determine the structure of the document.

The system 10 further includes a database engine 16 for performing various operations on and in connection with data stored in the XML database 12, including the XML document 13. As will be described in greater detail hereinbelow, an XML index definition document (“XIDD”) 18 is provided by the application 14 to the database engine 16. The database engine 16 stores the XIDD 18 in a dictionary collection 20 of the database 12 and generates a set of index keys 22 by applying the XIDD to the XML document 13. The index keys 22 point back to the nodes in the XML document 13 from which they were generated.

In one embodiment, the XML database 12 is a model based native XML database, such as Novell Corporation's XFLAIM database, for example. It will be recognized that, although portions of the embodiments described herein may be described with reference to the XFLAIM database, such descriptions are for the purposes of example only and that the embodiments described herein may be advantageously implemented using other types of XML databases as well.

As described in the aforementioned related application, which has been incorporated by reference in its entirety, the database engine 16 creates an in-memory tree structure that correspond to the tree structure if the XIDD 18. This structure is used to populate the index keys 22 as XML documents are added, modified, or deleted in the database 12.

As previously noted, the most basic unit of information in the XML database 12 is a node, such as an ElementComponent (also referred to herein as an “element” or “element node”), or an AttributeComponent (also referred to herein as an “attribute” or an “attribute node”). Every node in the database 12 is uniquely addressable by a Nodeld. Within the XML document 13, one node can be placed subordinate to another node; the nodes are then said to have a “parent-child” relationship. A node may have at most one parent node. Nodes that have the same parent are referred to as “siblings”.

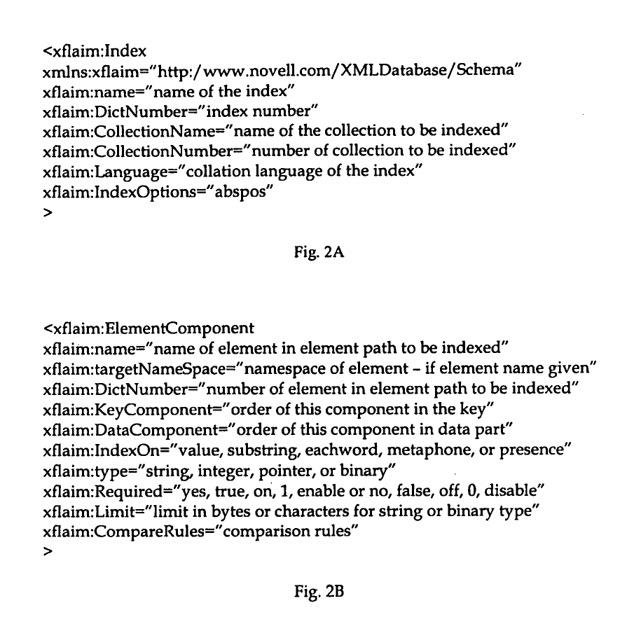

FIGS. 2A-2C illustrates syntaxes for defining an index, an ElementComponent, and an AttributeComponent, respectively, in accordance with one embodiment. It will be recognized that an ElementComponent can contain other ElementComponents and/or AttributeComponents. As will be described in greater detail below, in accordance with the embodiments described herein, the relationship among the nodes identified as key components as specified in an index definition defines the expected relationship of the nodes they reference in an XML document that is being indexed. When the defined relationships are found within the XML document, a set of index keys is created from the specified nodes. As will be shown, not every ElementComponent is necessarily a key component in the index definition. Some are present only to specify context for the other nodes.

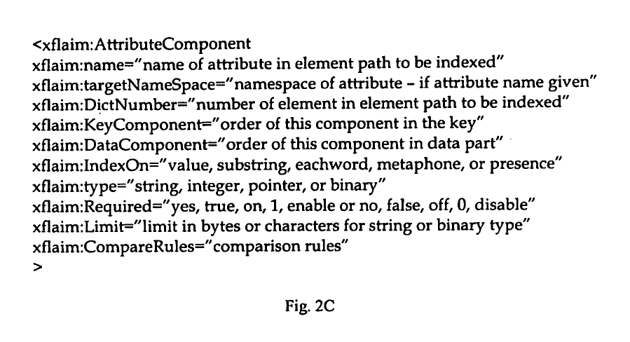

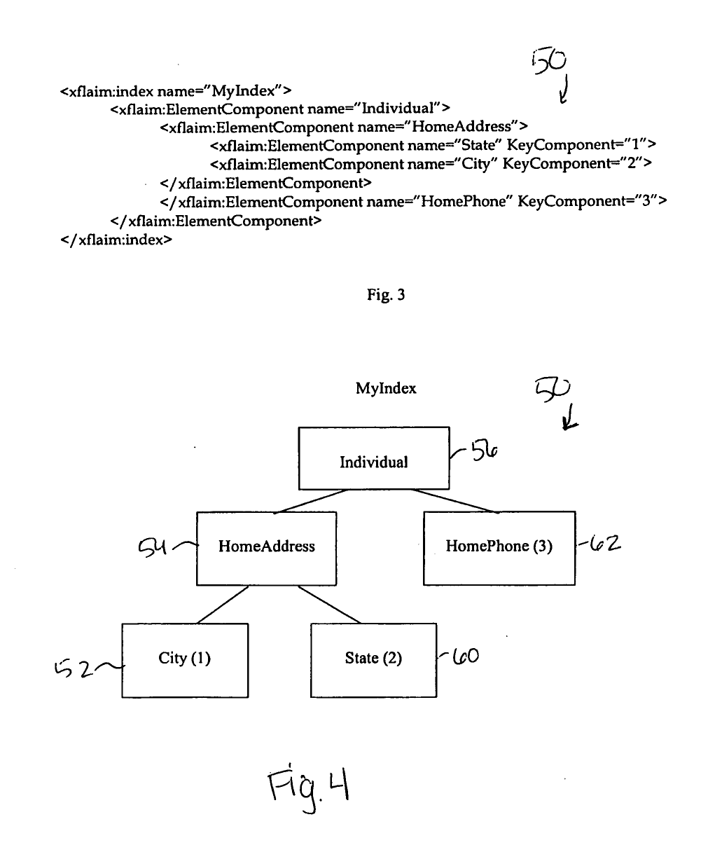

The combination of arbitrary nesting of ElementComponents, the nesting of AttributeComponents under the Element Components, and the arbitrary designation of which nodes are to be considered key components may be used to define an index that can have any number of factors or keys. A “simple index” is one in which a single key component is identified; a “compound index” is one in which more than one key components are identified. FIG. 3 illustrates an XML document comprising an index definition document 50 designated “Mylndex”. FIG. 4 is a schematic representation of the index definition document 50 shown in FIG. 3. As best illustrated in FIG. 4, the index definition document 50 defines a compound index consisting of three key components. The first key component (“KeyComponent=1”) is a City element 52 that is subordinate to a HomeAddress element 54 that is subordinate to an Individual element 56; in other words, the City element 52 is the child of the HomeAddress element 56 which is the child of the Individual element 58. The second key component (“KeyComponent=2”) is a State element 60 that is subordinate to the HomeAddress element 56, which is subordinate to the Individual element 58; in other words, the State element 60 is a sibling of the City element 52. The third key component (“KeyComponent=3”) is a HomePhone element 62 that is subordinate to the Individual element 56; in other words, the HomePhone element 62 is a sibling of the HomeAddress element 54.

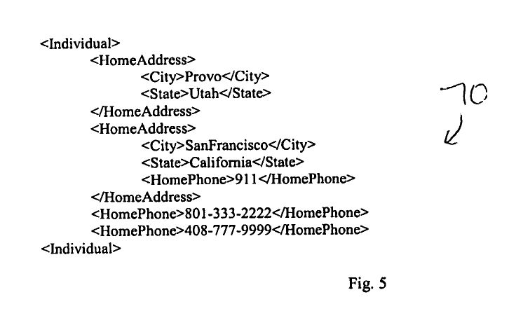

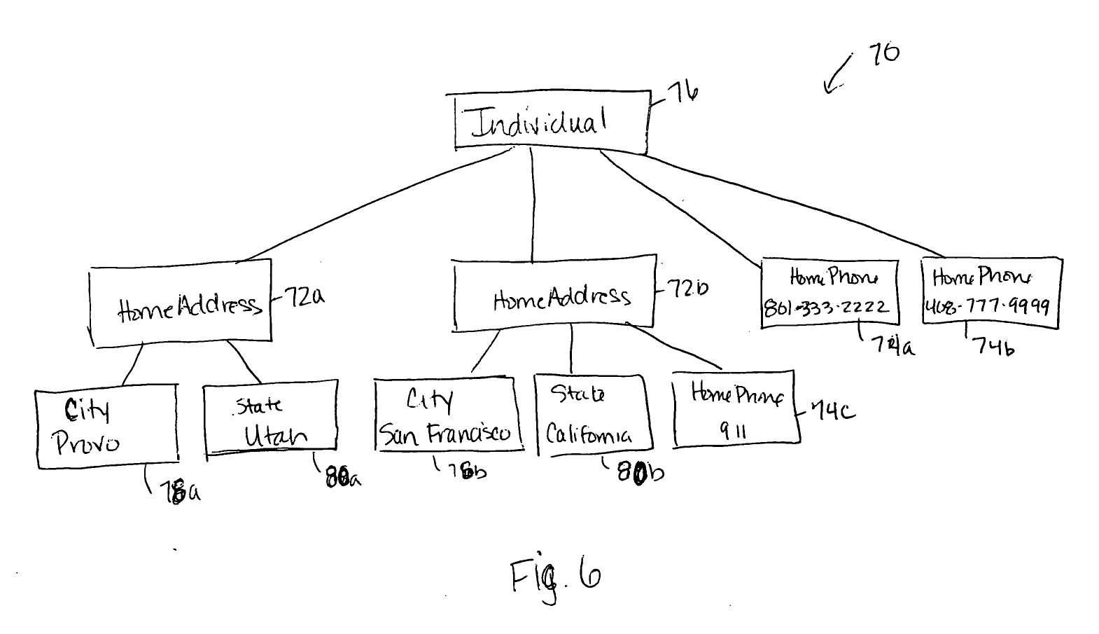

FIG. 5 illustrates an XML document 70 such as might be stored in the XML database 12. FIG. 6 is a schematic representation of the XML document 70 shown in Fig. 5. As best illustrated in FIG. 6, the XML document 70 includes two HomeAddress elements 72a and 72b, and three HomePhone elements 74a-74c. The HomeAddress elements 72a and 72b and the HomePhone elements 74a and 74b are subordinate to an Individual element 76. The document 70 also includes two City elements 78a and 78b, and two State elements 80a and 80b. The City element 78a and the State element 80a are siblings and are subordinate to, or are children of, the HomeAddress element 72a. The City element 78b, the State element 80b, and the HomePhone element 74c are siblings and are subordinate to, or children of, the HomeAddress element 72b.

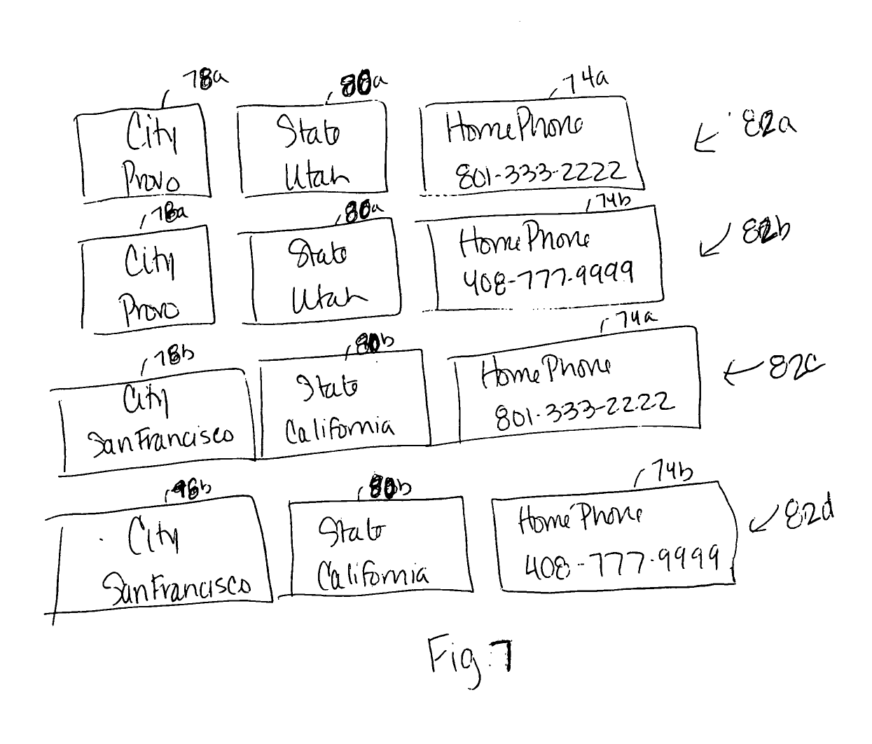

Applying the index definition document 50 (FIGS. 3 and 4) to the XML document (FIGS. 5 and 6), results in the generation of a set of index keys. As shown in FIG. 7, a first key 82a comprises the combination of elements including the City element 78a, the State element 80a, and the HomePhone element 74a. the second key 82b comprises the combination of elements including the City element 78a, the State element 80a, and the HomePhone element 74b. The third key 82c comprises the combination of elements including the City element 78b, the State element 80b, and the HomePhone element 74a. Finally, the fourth key 82d comprises the combination of elements including the City element 78b, the State element 80b, and the HomePhone element 74b.

As noted above with reference to FIG. 1, the index keys 82a-82d will be stored in an XML database along with the XML document 70 and each key will point to the nodes in the XML document from which they were generated.

As a practical matter, it will be recognized that it might have made more sense to have nested the HomePhone elements 74a and 74b under the HomeAddress elements 72a and 72b, respectively, in the document 70 (FIG. 6) and to have changed the index definition document 50 accordingly (such that the key component comprising the HomePhone element 62 is nested under the HomeAddress element 54) (FIG. 4); however, the examples illustrated in FIGS. 3-6 were designed to illustrate the embodiments described herein to generate index keys in accordance with an index definition.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. Therefore, the claims should be interpreted in a broad manner, consistent with the present disclosure.

What is claimed is:

1. A system for providing compound indexes for documents comprising hierarchical, semi-structured data, the system comprising:
a database for storing a document comprising hierarchical, semi-structured data;
a database engine for performing operations on and in connection with data stored in the database; and
an index definition document (“IDD”) for defining an index for the document;
wherein the database engine applies the IDD to the document to generate a set of index keys for the document.

2. The system of claim 1 wherein the document is an XML document and wherein the IDD is an XML document.

3. The system of claim 1 wherein the IDD is provided to the database engine by an application.

4. The system of claim 3 wherein the document comprises data of the application.

5. The system of claim 1 wherein the IDD defines at least two nodes of the document as key component nodes.

6. The system of claim 5 wherein the IDD defines at least one node of the document as a context-only node, wherein the context-only node defines a context for at least one of the key component nodes within the document.

7. The system of claim 1 wherein the IDD defines at least one set of relationships among nodes in the document.

8. The system of claim 1 wherein the index keys are stored in the database.

9. The system of claim 1 wherein the index keys point to nodes in the document corresponding to the index keys.

10. A method for providing compound indexes for documents comprising hierarchical, semi-structured data, the method comprising:
storing a document comprising hierarchical, semi-structured data in a database;
providing an index definition document (“IDD”) for defining an index for the document; and
applying the IDD to the document stored in the database to generate a set of index keys for the document.

11. The method of claim 10 wherein the document comprises an XML document.

12. The method of claim 10 wherein the IDD comprises an XML document.

13. The method of claim 10 wherein the IDD is provided by an application and the document stored in the database comprises data of the application.

14. The method of claim 10 wherein the IDD defines at least two nodes of the document as key component nodes.

15. The method of claim 14 wherein the IDD defines at least one node of the document as a context-only node, wherein the context-only node defines a context for at least one of the key component nodes within the document.

16. The method of claim 10 wherein the IDD defines at least one set of relationships among nodes in the document.

17. The method of claim 10 comprising storing the index keys are in the database.

18. The method of claim 17 wherein the index keys point to nodes in the document to which the index keys correspond.

19. A system for providing compound indexes for XML documents, the method comprising:
means for storing an XML document comprising data of an application in an XML database;
means for receiving from the application an XML index definition document (“XIDD”), the XIDD for defining an index for the XML document;
means for applying the XIDD to the XML document to generate a set of index keys for the XML document; and
means for storing the set of index keys in the XML database, wherein the index keys point to nodes in the XML document to which the index keys correspond.

20. The system of claim 19 wherein the XIDD defines at least two nodes of the XML document as key component nodes.

21. The system of claim 20 wherein the XIDD defines at least one node of the XML document as a context-only node, wherein the context-only node defines a context for at least one of the key component nodes within the XML document.

22. The system of claim 19 wherein the XIDD defines at least one set of relationships among nodes in the XML document.
